(19) United States
(12) Patent Application Publication
(10) Pub. No.: US 2025/0349880 A1
(43) Pub. Date: Nov. 13, 2025

(54) IONIC LIQUID ELECTROLYTES FOR BATTERIES THAT CYCLE LITHIUM IONS AND BATTERIES INCLUDING THE SAME

(71) Applicant: GM GLOBAL TECHNOLOGY OPERATIONS LLC, Detroit, MI (US)

(72) Inventors: Zhe LI, Shanghai (CN); Qili Su, Shanghai (CN); Xin Zhang, Shanghai (CN); Thomas A. Yersak, Royal Oak, MI (US); Yifan Zhao, Troy, MI (US); Jeffrey David Cain, Royal Oak, MI (US)

(21) Appl. No.: 18/762,849

(22) Filed: Jul. 3, 2024

(30) Foreign Application Priority Data
May 10, 2024 (CN) 2024105786353

(51) Int. Cl. H01M 10/056; H01M 4/02; H01M 4/134; H01M 4/38; H01M 4/62; H01M 50/411; H01M 50/491; H01M 50/497

(52) U.S. Cl. CPC H01M 10/056; H01M 4/134; H01M 4/386; H01M 4/622; H01M 50/411; H01M 50/491; H01M 50/497; H01M 2004/027; H01M 2004/028; H01M 2300/0068

(57) ABSTRACT

An electrolyte for a battery that cycles lithium ions includes a glyme-based ionic liquid and a cyclic ammonium-based ionic liquid. The glyme-based ionic liquid includes substantially equimolar amounts of a cation component including a complex of lithium (Li₊) and a glyme and an anion component including an arsenate ion, a phosphate ion, a sulfonylimide ion, a borate ion, and/or a chlorate ion. The cyclic ammonium-based ionic liquid includes a cation component including a piperidinium ion and/or a pyrrolidinium ion and an anion component including an arsenate ion, a phosphate ion, a sulfonylimide ion, a borate ion, and/or a chlorate ion. The electrolyte has a lithium concentration of greater than or equal to 0.2 moles per liter and less than or equal to 1.6 moles per liter. The electrolyte may be used in batteries that cycle lithium ions and that include silicon-containing electroactive negative electrode materials.

### CROSS-REFERENCE TO RELATED APPLICATIONS

This application claims the benefit of Chinese Patent Application No. 202410578635.3 filed on May 10, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to ionic liquid electrolytes for batteries that comprise silicon-containing negative electrodes and optionally sulfide-based solid electrolytes.

Lithium batteries are used in a wide variety of electronic devices and are a promising candidate to fulfill the requirements of electric vehicles, including hybrid electric vehicles, owing to their high energy and power densities. Secondary lithium batteries generally include a negative electrode, a positive electrode, and an electrolyte that provides a medium for the conduction of lithium ions between the negative and positive electrodes during discharge and charge of the battery. The electrolyte may be formulated to exhibit certain desirable properties including high ionic conductivity, good thermal stability, a wide electrochemical stability window, ability to form a stable ionically conductive solid electrolyte interphase on the surface of the positive electrode and/or the negative electrode, and chemical compatibility with other components of the batteries.

### SUMMARY

An electrolyte for a battery that cycles lithium ions, in accordance with one or more embodiments of the present disclosure, comprises a glyme-based ionic liquid and a cyclic ammonium-based ionic liquid. The glyme-based ionic liquid comprises substantially equimolar amounts of a cation component and an anion component, with the cation component comprising a complex of lithium (Li⁺) and a glyme and the anion component comprising an arsenate ion, a phosphate ion, a sulfonylimide ion, a borate ion, a chlorate ion, or a combination thereof. The cyclic ammonium-based ionic liquid comprises a cation component and an anion component, with the cation component comprising a piperidinium ion, a pyrrolidinium ion, or a combination thereof and the anion component comprising an arsenate ion, a phosphate ion, a sulfonylimide ion, a borate ion, a chlorate ion, or a combination thereof. The electrolyte has a lithium concentration of greater than or equal to 0.2 moles per liter and less than or equal to 1.6 moles per liter.

The electrolyte may have a viscosity of greater than or equal to 10 millipascal-seconds and less than or equal to 100 millipascal-seconds and an ionic conductivity of greater than or equal to 4 milliSiemens per centimeter and less than or equal to 10 milliSiemens per centimeter at 25 degrees Celsius.

The glyme-based ionic liquid may have a viscosity of greater than 100 millipascal-seconds and the cyclic ammonium-based ionic liquid may have a viscosity of less than 100 millipascal-seconds at 25 degrees Celsius.

The glyme-based ionic liquid may have an ionic conductivity of less than or equal to 2 milliSiemens per centimeter and the cyclic ammonium-based ionic liquid may have an ionic conductivity of greater than or equal to 4 milliSiemens per centimeter at 25 degrees Celsius.

The cation component of the glyme-based ionic liquid may comprise a complex of lithium (Li⁺) and monoglyme, ethyl glyme, diglyme, ethyl diglyme, triglyme, butyl diglyme, tetraglyme, or a combination thereof. The anion component of the glyme-based ionic liquid may comprise hexafluoroarsenate (AsF₆⁻), hexafluorophosphate (PF₆⁻), bis(fluorosulfonyl)imide (FSI), bis(trifluoromethane)sulfonylimide (TFSI), tetrafluoroborate (LiBF₄⁻), perchlorate (ClO₄⁻), or a combination thereof.

The glyme-based ionic liquid may be formed from a mixture of a glyme and a lithium salt. A molar ratio of the glyme to the lithium salt in the mixture may be greater than or equal to 0.7:1 and less than or equal to 1.2:1.

The cation component of the cyclic ammonium-based ionic liquid may comprise 1-methyl-1-ethylpyrrolidinium ([Py₁₂]⁺), 1-propyl-1-methylpyrrolidinium ([Py₁₃]⁺), 1-butyl-1-methylpyrrolidinium ([Py₁₄]⁺), 1-propyl-1-methylpiperidinium ([PP₁₃]⁺), 1-butyl-1-methylpiperidinium ([PP₁₄]⁺), or a combination thereof. The anion component of the cyclic ammonium-based ionic liquid may comprise hexafluoroarsenate (AsF₆⁻), hexafluorophosphate (PF₆⁻), bis(fluorosulfonyl)imide (FSI), bis(trifluoromethane)sulfonylimide (TFSI), tetrafluoroborate (LiBF₄⁻), perchlorate (ClO₄⁻), or a combination thereof.

In aspects, the cation component of the glyme-based ionic liquid may comprise a complex of lithium (Li⁺) and tetraglyme, the anion component of the glyme-based ionic liquid may comprise bis(fluorosulfonyl)imide (FSI), the cation component of the cyclic ammonium-based ionic liquid may comprise 1-propyl-1-methylpyrrolidinium ([Py₁₃]⁺), and the anion component of the cyclic ammonium-based ionic liquid may comprise bis(fluorosulfonyl)imide (FSI).

A volumetric ratio of the glyme-based ionic liquid to the cyclic ammonium-based ionic liquid in the electrolyte may be greater than or equal to 1:10 and less than or equal to 2:1.

The electrolyte may be substantially free of nonaqueous aprotic organic solvents.

A battery that cycles lithium ions, in accordance with one or more embodiments of the present disclosure, comprises a negative electrode, a positive electrode spaced apart from the negative electrode, a porous separator disposed between the negative electrode and the positive electrode and having a plurality of open pores extending therethrough, and an electrolyte infiltrating the open pores of the porous separator and configured to provide a medium for the conduction of lithium ions through the porous separator and between the negative electrode and the positive electrode. The negative electrode comprises an electroactive negative electrode material comprising silicon. The positive electrode comprises an electroactive positive electrode material. The electrolyte comprises a glyme-based ionic liquid and a cyclic ammonium-based ionic liquid. The glyme-based ionic liquid comprises substantially equimolar amounts of a cation component and an anion component, with the cation component comprising a complex of lithium (Li⁺) and a glyme and the anion component comprising an arsenate ion, a phosphate ion, a sulfonylimide ion, a borate ion, a chlorate ion, or a combination thereof. The cyclic ammonium-based ionic liquid comprises a cation component and an anion component, with the cation component comprising a piperidinium ion, a pyrrolidinium ion, or a combination thereof and the anion component comprising an arsenate ion, a phosphate ion, a sulfonylimide ion, a borate ion, a chlorate ion, or a combination thereof. The electrolyte has a lithium concentration of greater than or equal to 0.2 moles per liter and less than or equal to 1.6 moles per liter.

The electrolyte may have a viscosity of greater than or equal to 10 millipascal-seconds and less than or equal to 100 millipascal-seconds and an ionic conductivity of greater than or equal to 4 milliSiemens per centimeter and less than or equal to 10 milliSiemens per centimeter at 25 degrees Celsius.

A molar ratio of the cation component to the anion component in the glyme-based ionic liquid may be greater than or equal to 0.7:1 and less than or equal to 1.2:1.

In aspects, the cation component of the glyme-based ionic liquid may comprise a complex of lithium (Li⁺) and tetraglyme, the anion component of the glyme-based ionic liquid may comprise bis(fluorosulfonyl)imide (FSI), the cation component of the cyclic ammonium-based ionic liquid may comprise 1-propyl-1-methylpyrrolidinium ([Py₁₃]⁺), and the anion component of the cyclic ammonium-based ionic liquid may comprise bis(fluorosulfonyl)imide (FSI).

A volumetric ratio of the glyme-based ionic liquid to the cyclic ammonium-based ionic liquid in the electrolyte may be greater than or equal to 1:10 and less than or equal to 2:1.

The porous separator may comprise solid electrolyte particles. In such case, the solid electrolyte particles may comprise a sulfide-based solid electrolyte material. The sulfide-based solid electrolyte material may comprise lithium sulfide (Li₂S) and at least one element selected from the group consisting of phosphorus (P), tin (Sn), silicon (Si), germanium (Ge), boron (B), gallium (Ga), and aluminum (Al).

The negative electrode further may comprise a polymer binder, an electrically conductive material, and sulfide-based solid electrolyte particles.

The porous separator may comprise a polymer-based membrane.

The electroactive positive electrode material may comprise sulfur.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a negative electrode, a positive electrode, a porous separator defined by a plurality of solid electrolyte particles, and an electrolyte infiltrating pores of the negative electrode, the positive electrode, and the porous separator, the electrolyte comprising a mixture of a glyme-based ionic liquid and a cyclic ammonium-based ionic liquid.

FIG. 4 is a schematic cross-sectional view of a battery that cycles lithium ions, the battery comprising a negative electrode, a positive electrode, a porous separator in the form of a polymer-based membrane, and an electrolyte infiltrating pores of the negative electrode, the positive electrode, and the porous separator, the electrolyte comprising a mixture of a glyme-based ionic liquid and a cyclic ammonium-based ionic liquid.

In the drawings, reference numbers may be reused to identify similar and/or identical elements.

### DETAILED DESCRIPTION

The presently disclosed electrolytes comprise a mixture of a glyme-based ionic liquid and a cyclic ammonium-based ionic liquid and are formulated for use in batteries that cycle lithium ions to establish robust lithium ion transport pathways therethrough. The presently disclosed electrolytes are chemically compatible with sulfide-based solid electrolytes, as well as with silicon-containing negative electrode materials, and thus may help improve the cycling stability of batteries including such materials. The cyclic ammonium-based ionic liquid is included in the presently disclosed electrolytes in an amount sufficient to provide the electrolytes with a relatively low viscosity and a relatively high ionic conductivity, as compared to that of the glyme-based ionic liquid, which may allow the presently disclosed electrolytes to be used in batteries that require relatively high charge and discharge rate capabilities.

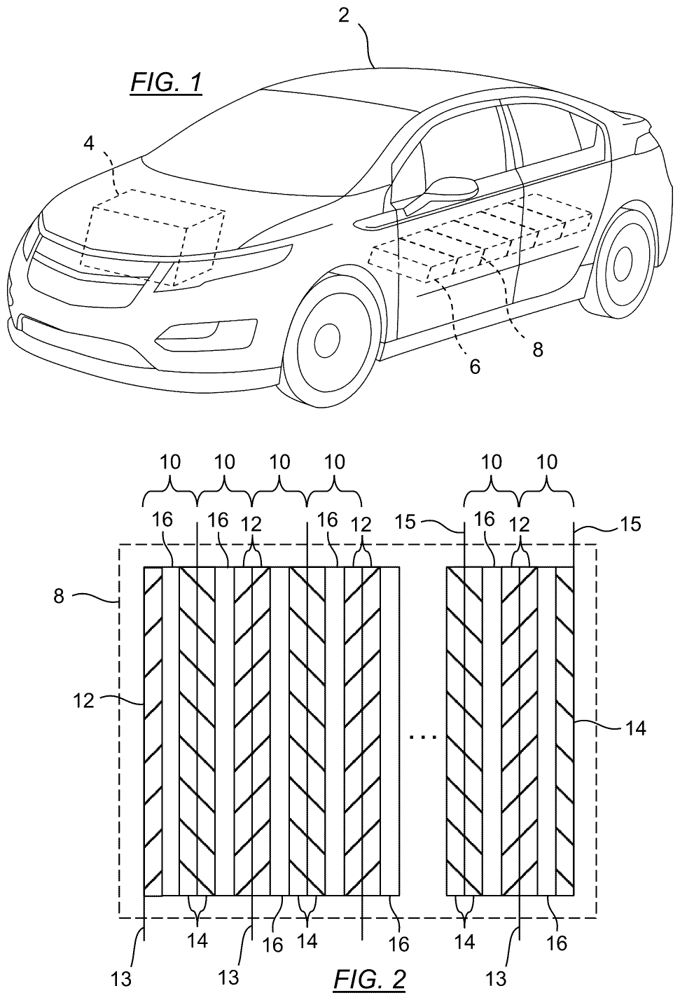

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

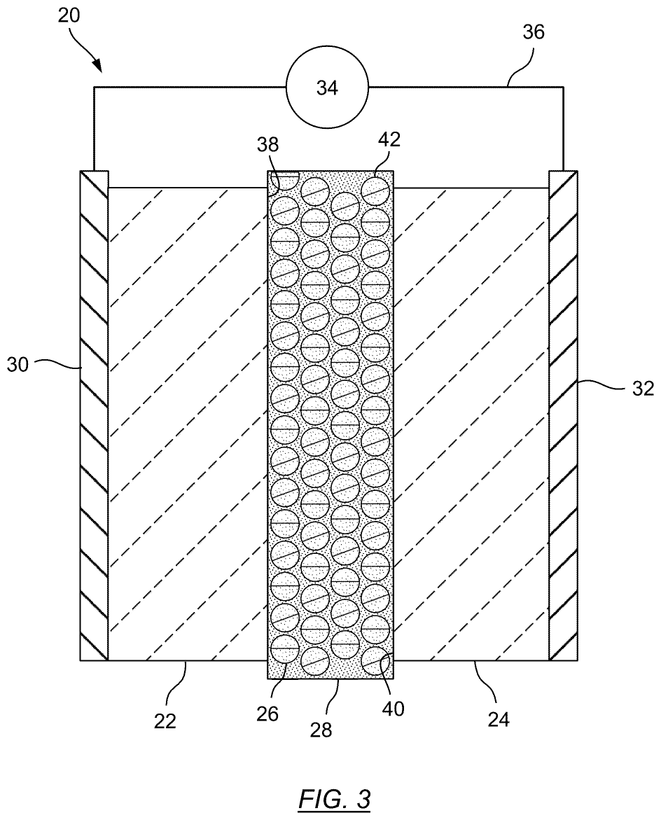

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a porous separator 26, and an electrolyte 28 infiltrating open pores defined within the negative electrode 22, the positive electrode 24, and the porous separator 26. The negative electrode 22 is disposed on a major surface of a negative electrode current collector 30 and has a major surface 38 that faces toward the positive electrode 24. The positive electrode 24 is disposed on a major surface of a positive electrode current collector 32 and has a major surface 40 that faces toward the negative electrode 22. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the electrolyte 28 and the porous separator 26, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The electrolyte 28 is ionically conductive and is formulated to provide a medium for the conduction of lithium ions through and between the negative electrode 22, the positive electrode 24, and the porous separator 26. The electrolyte 28 is formulated to have high ionic conductivity, high thermal stability, low volatility, and exceptional stability against electrochemical oxidation and reduction, and to provide the battery 20 with relatively high charge and discharge rate capabilities and improved cycling stability. The electrolyte 28 wets the major surface 38 of the negative electrode 22 and the major surface 40 of the positive electrode 24 and infiltrates the open pores defined in the negative electrode 22, the positive electrode 24, and the porous separator 26. The electrolyte 28 is formulated to promote the conduction of lithium ions through the battery 20 and to maximize the capacity of the battery 20, for example, by establishing robust lithium ion transport channels through the negative electrode 22, the positive electrode 24, and the porous separator 26 and by establishing robust interfacial contact with the electroactive materials of the negative electrode 22 and the positive electrode 24.

The electrolyte 28 comprises a mixture of a glyme-based ionic liquid and a cyclic ammonium-based ionic liquid. The glyme-based ionic liquid is formulated to provide the electrolyte 28 with high thermal stability, low volatility, exceptional stability against electrochemical oxidation and reduction, and good chemical compatibility with sulfide-based solid electrolyte materials. The cyclic ammonium-based ionic liquid is formulated to dilute the glyme-based ionic liquid and thereby provide the electrolyte 28 with a desirably low viscosity. In addition, the cyclic ammonium-based ionic liquid is formulated to provide the electrolyte 28 with high ionic conductivity and good chemical compatibility with silicon-containing electroactive negative electrode materials, which may help improve the cycling stability of the battery 20. The glyme-based ionic liquid may have a relatively high viscosity and a relatively low ionic conductivity, as compared to that of the cyclic ammonium-based ionic liquid. The cyclic ammonium-based ionic liquid may be included in the electrolyte 28 in an amount sufficient to provide the electrolyte 28 with a suitably low viscosity and a sufficiently high ionic conductivity. In aspects, a volumetric ratio of the glyme-based ionic liquid to the cyclic ammonium-based ionic liquid in the electrolyte 28 (glyme-based ionic liquid:cyclic ammonium-based ionic liquid) may be greater than or equal to 1:10, optionally greater than or equal to 1:8, optionally greater than or equal to 1:6, or optionally greater than or equal to 1:4, and less than or equal to 2:1, optionally less than or equal to 1:1, or optionally less than or equal to 1:2.

In aspects, the electrolyte 28 may have a viscosity of greater than or equal to 10 millipascal-seconds (mPa·s), optionally greater than or equal to 20 mPa·s, or optionally greater than or equal to 40 mPa·s, and less than or equal to 110 mPa·s, optionally less than or equal to 100 mPa·s, optionally less than or equal to 80 mPa·s, or optionally less than or equal to 60 mPa·s at about 25 degrees Celsius (° C.). The electrolyte 28 may have an ionic conductivity of greater than or equal to 1 milliSiemen per centimeter (mS/cm), optionally greater than or equal to 2 mS/cm, optionally greater than or equal to 3 mS/cm, optionally greater than or equal to 4 mS/cm, or optionally greater than or equal to 4.5 mS/cm, and less than or equal to 10 mS/cm at about 25° C. The lithium ion (Li⁺) concentration in the electrolyte 28 may be greater than or equal to 0.2 moles per liter (mol/L or Molar), optionally greater than or equal to 0.5 Molar, or optionally greater than or equal to 0.8 Molar, and less than or equal to 1.6 Molar, optionally less than or equal to 1.5 Molar, or optionally less than or equal to 1.2 Molar. In aspects, the Li⁺ concentration in the electrolyte 28 may be about 1 Molar.

The glyme-based ionic liquid comprises a cation component and an anion component. In embodiments, the cation component and the anion component may be present in the glyme-based ionic liquid in substantially equimolar amounts and the glyme-based ionic liquid may be referred to as a solvate ionic liquid. The glyme-based ionic liquid may have a viscosity of greater than or equal to 100 mPa·s, optionally greater than or equal to 110 mPa·s, optionally greater than or equal to 150 mPa·s, or optionally greater than or equal to 180 mPa·s, and an ionic conductivity of greater than or equal to 1 mS/cm and less than or equal to 2 mS/cm at about 25° C.

The cation component of the glyme-based ionic liquid comprises a complex of lithium (Li⁺) and a glyme. Glymes are glycol diethers having the formula R(OCH₂CH₂)ₙOR, where n is 1, 2, 3, or 4 and R is methyl (—CH₃ or Me), ethyl (—CH₂CH₃ or Et), or butyl (—CH₂CH₂CH₂CH₃ or Et). Specific examples of glymes include monoglyme (n=1 and R=Me), ethyl glyme, diglyme, ethyl diglyme, triglyme, butyl diglyme, and tetraglyme. In aspects, the cation component of the glyme-based ionic liquid comprises a complex of lithium (Li⁺) and tetraglyme.

The anion component of the glyme-based ionic liquid comprises an arsenate ion, a phosphate ion, a sulfonylimide ion, a borate ion, a chlorate ion, or a combination thereof. An example of an arsenate ion is hexafluoroarsenate (AsF₆⁻). An example of a phosphate ion is hexafluorophosphate (PF₆⁻). Examples of sulfonylimide ions include bis(fluorosulfonyl)imide (N(FSO₂)₂⁻) (FSI), bis(trifluoromethane)sulfonylimide (N(CF₃SO₂)₂⁻) (TFSI), and combinations thereof. An example of a borate ion is tetrafluoroborate (LiBF₄⁻). An example of a chlorate ion is perchlorate (ClO₄⁻). In aspects, the anion component of the glyme-based ionic liquid comprises bis(fluorosulfonyl)imide (FSI).

The glyme-based ionic liquid may be formed from a mixture of a glyme and a lithium salt. In such case, the glyme may comprise monoglyme, ethyl glyme, diglyme, ethyl diglyme, triglyme, butyl diglyme, tetraglyme, or a combination thereof, and the lithium salt may comprise lithium hexafluoroarsenate (LiAsF₆), lithium hexafluorophosphate (LiPF₆), lithium bis(trifluoromethane)sulfonylimide (LiN(CF₃SO₂)₂) (LiTFSI), lithium bis(fluorosulfonyl)imide (LiN(FSO₂)₂) (LiFSI), lithium tetrafluoroborate (LiBF₄), lithium perchlorate (LiClO₄), or a combination thereof. In aspects, the glyme-based ionic liquid may be formed from a mixture of tetraglyme and LiFSI. In embodiments, the glyme and the lithium salt may be mixed in substantially equimolar amounts to form the glyme-based ionic liquid. For example, a molar ratio of the glyme to the lithium salt (glyme:lithium salt) in the glyme-based ionic liquid may be greater than or equal to 0.7:1, optionally greater than or equal to 0.8:1, or optionally greater than or equal to 0.9:1, and less than or equal to 1.2:1, or optionally less than or equal to 1.1:1. In aspects, a molar ratio of the glyme to the lithium salt (glyme:lithium salt) in the glyme-based ionic liquid may be about 1:1.

The cyclic ammonium-based ionic liquid comprises a cation component and an anion component. The cyclic ammonium-based ionic liquid may have a viscosity of greater than or equal to 10 mPa·s, optionally greater than or equal to 20 mPa·s, or optionally greater than or equal to 30 mPa·s, and less than or equal to 100 mPa·s, optionally less than or equal to 60 mPa·s, or optionally less than or equal to 50 mPa·s at about 25° C. In aspects, the cyclic ammonium-based ionic liquid may have a viscosity of about 40 mPa·s at about 25° C. The cyclic ammonium-based ionic liquid may have an ionic conductivity of greater than or equal to 4 mS/cm, optionally greater than or equal to 6 mS/cm, or optionally greater than or equal to 8 mS/cm, and less than or equal to 12 mS/cm, or optionally less than or equal to 10 mS/cm at about 25° C.

The cation component of the cyclic ammonium-based ionic liquid comprises a piperidinium ion, a pyrrolidinium ion, or a combination thereof. Examples of pyrrolidinium ions include 1-methyl-1-ethylpyrrolidinium ([Py₁₂]⁺), 1-propyl-1-methylpyrrolidinium ([Py₁₃]⁺), and 1-butyl-1-methylpyrrolidinium ([Py₁₄]⁺). Examples of piperidinium ions include 1-propyl-1-methylpiperidinium ([PP₁₃]⁺) and 1-butyl-1-methylpiperidinium ([PP₁₄]⁺). In aspects, the cation component of the cyclic ammonium-based ionic liquid comprises [Py₁₃]⁺.

The anion component of the cyclic ammonium-based ionic liquid comprises an arsenate ion, a phosphate ion, a sulfonylimide ion, a borate ion, a chlorate ion, or a combination thereof. For example, the anion component of the cyclic ammonium-based ionic liquid may comprise hexafluoroarsenate (AsF₆⁻), hexafluorophosphate (PF₆⁻), bis(fluorosulfonyl)imide (FSI), bis(trifluoromethane)sulfonylimide (TFSI), tetrafluoroborate (LiBF₄⁻), perchlorate (ClO₄⁻), or a combination thereof. In aspects, the anion component of the cyclic ammonium-based ionic liquid comprises bis(fluorosulfonyl)imide (FSI).

In embodiments where the electroactive material of the negative electrode 22 comprises silicon and the anion component of the glyme-based ionic liquid and/or the anion component of the cyclic ammonium-based ionic liquid comprises bis(fluorosulfonyl)imide (N(FSO₂)₂⁻) (FSI), the N(SO₂F)₂⁻ anions in the electrolyte 28 may participate in the in situ formation of a solid electrolyte interphase on surfaces of the electroactive material of the negative electrode 22 during initial and/or repeated cycling of the battery 20. The solid electrolyte interphase formed on the electroactive material of the negative electrode 22 is electrically insulating and ionically conductive and, when present, may help prevent undesirable chemical reactions from occurring between the electrolyte 28 and the electroactive material of the negative electrode 22 during cycling of the battery 20. During formation of the solid electrolyte interphase, the N(SO₂F)₂⁻ anions in the electrolyte 28 may react with the silicon and the lithium in the electroactive material of the negative electrode 22 and decompose to form inorganic compounds, such as lithium fluoride (LiF), lithium silicate (LiₓSiO_{y}), lithium silicide (LiₓSi), and combinations thereof. The inorganic decomposition products of the N(SO₂CF₃)₂⁻ anions may deposit on the electroactive material of the negative electrode 22 and form the solid electrolyte interphase. As such, the solid electrolyte interphase formed on the electroactive material of the negative electrode 22 may comprise lithium fluoride (LiF), lithium silicate (LiₓSiO_{y}), lithium silicide (LiₓSi), or a combination thereof.

In embodiments, the electrolyte 28 may be substantially free of lithium bis(trifluoromethanesulfonyl)imide (LiTFSI) and may be substantially free of bis(trifluoromethanesulfonyl)imide N(SO₂CF₃)₂⁻ anions. Without intending to be bound by theory, it is believed that, when silicon is used as an electroactive negative electrode material and N(SO₂CF₃)₂⁻ anions are included in the electrolyte of a battery that cycles lithium ions (such as the battery 20), the N(SO₂CF₃)₂⁻ anions may decompose on the surface of the electroactive negative electrode material during cycling of the battery and form organic compounds (e.g., SO₂CF₃⁻ and NSO₂CF₃²⁻), which may lead to the formation of a relatively thick and unstable solid electrolyte interphase on surfaces of the electroactive negative electrode material, as compared to batteries in which N(SO₂F)₂⁻ anions are included in the electrolyte (such as in the ionogel electrolyte 28). The formation of the relatively thick, unstable organic compound-containing solid electrolyte interphase on the surfaces of the electroactive negative electrode material may lead to rapid capacity fade.

In embodiments, the electrolyte 28 may be substantially free of nonaqueous aprotic organic solvents. Non-limiting examples of non-aqueous aprotic organic solvents that may be excluded from the composition of the electrolyte 28 include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof.

As shown in FIG. 3, in embodiments, the porous separator 26 may be at least partially defined by solid electrolyte particles 42, which may be disposed between the major surface 38 of the negative electrode 22 and the major surface 40 of the positive electrode 24. In embodiments where the porous separator 26 is at least partially defined by the solid electrolyte particles 42, the electrolyte 28 may infiltrate open pores defined between the solid electrolyte particles 42 themselves and may infiltrate gaps and/or pores defined between the solid electrolyte particles 42 and the electroactive materials of the negative electrode 22 and the positive electrode 24. In this way, the electrolyte 28 may create lithium ion transfer pathways or “bridges” between the solid electrolyte particles 42 and the electroactive materials of the negative electrode 22 and the positive electrode 24. In aspects, the electrolyte 28 may infiltrate greater than or equal to 5% and less than or equal to 100% of the open pores defined between the solid electrolyte particles 42. In aspects, the electrolyte 28 may infiltrate about 80% of the open pores defined between the solid electrolyte particles 42. The solid electrolyte particles 42 may have a mean particle diameter of greater than or equal to about 1 μm and less than or equal to about 20 μm. The solid electrolyte particles 42 may comprise an oxide-based solid electrolyte material, a metal-doped or aliovalent-substituted oxide solid electrolyte material, a sulfide-based solid electrolyte material, a nitride-based solid electrolyte material, a hydride-based solid electrolyte material, a halide-based solid electrolyte material, a borate-based solid electrolyte material, or a combination thereof.

Sulfide-based solid electrolyte materials may be at least partially crystalline and comprise lithium sulfide (Li₂S) and at least one element selected from the group consisting of phosphorus (P), tin (Sn), silicon (Si), germanium (Ge), boron (B), gallium (Ga), and aluminum (Al). For example, sulfide-based solid electrolyte materials may comprise Li₂S and at least one additional inorganic compound selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), arsenic sulfide (As₂S₅), and manganese sulfide (MnS). In aspects, the solid electrolyte particles 42 may comprise a binary sulfide, a ternary sulfide, a quaternary sulfide, or a combination thereof. In aspects where the solid electrolyte particles 42 comprise a binary sulfide, the solid electrolyte particles 42 may comprise lithium sulfide (Li₂S) and at least one additional sulfide selected from the group consisting of phosphorus sulfide (P₂S₅), tin sulfide (SnS₂), silicon sulfide (SiS₂), germanium sulfide (GeS₂), boron sulfide (B₂S₃), gallium sulfide (Ga₂S₃), and aluminum sulfide (Al₂S₃). For example, the solid electrolyte particles 42 may comprise a binary sulfide of Li₂S—P₂S₅(e.g., Li₃PS₄, Li₇P₃S₁₁ and Li_{9.6}P₃S₁₂), Li₂S—SnS₂ (e.g., Li₄SnS₄), Li₂S—SiS₂, Li₂S—GeS₂, Li₂S—B₂S₃, Li₂S—Ga₂S₃, Li₂S—P₂S₃, Li₂S—Al₂S₃, or a combination thereof. In aspects where the solid electrolyte particles 42 comprise a ternary sulfide, the solid electrolyte particles 42 may comprise lithium sulfide (Li₂S) and at least two additional inorganic compounds selected from the group consisting of phosphorus sulfide (P₂S₅), tin sulfide (SnS₂), silicon sulfide (SiS₂), germanium sulfide (GeS₂), aluminum sulfide (Al₂S₃), lithium oxide (Li₂O), phosphorus oxide (P₂O₅), lithium fluoride (LiF), lithium chloride (LiCl), lithium bromide (LiBr), lithium iodide (LiI), and arsenic sulfide (As₂S₅). For example, the solid electrolyte particles 42 may comprise a ternary sulfide of Li₂O—Li₂S—P₂S₅, Li₂S—P₂S₅—P₂O₅, Li₂S—P₂S₅—GeS₂ (e.g., Li_{3.25}Ge_{0.25}P_{0.75}S₄ and/or Li₁₀GeP₂S₁₂), Li₂S—P₂S₅—LiX (where X is at least one of F, Cl, Br, and I) (e.g., Li₆PS₅Br, Li₆PS₅Cl, L₇P₂S₈I, and/or Li₄PS₄I), Li₂S—As₂S₅—SnS₂ (e.g., Li_{3.833}Sn_{0.833}As_{0.166}S₄), Li₂S—P₂S₅—Al₂S₃, Li₂S—LiX—SiS₂ (where X is at least one of F, Cl, Br, and I), 0.4LiI·0.6Li₄SnS₄, Li₁₁Si₂PS₁₂, or a combination thereof. In aspects where the solid electrolyte particles 42 comprise a quaternary sulfide, the solid electrolyte particles 42 may comprise lithium sulfide (Li₂S) and at least three additional inorganic compounds selected from the group consisting of phosphorus sulfide (P₂S₅), tin sulfide (SnS₂), silicon sulfide (SiS₂), lithium oxide (Li₂O), phosphorus oxide (P₂O₅), lithium chloride (LiCl), lithium iodide (LiI), and manganese sulfide (MnS). For example, the solid electrolyte particles 42 may comprise a quaternary sulfide of Li₂O—Li₂S—P₂S₅—P₂O₅, Li_{9.54}Si_{1.74}P_{1.44}S_{11.7}Cl_{0.3}, Li₇P_{2.9}Mn_{0.1}S_{10.7}I_{0.3}, Li_{10.35}[Sn_{0.27}Si_{1.08}]P_{1.65}S₁₂, or a combination thereof. In aspects, the solid electrolyte particles 42 may comprise lithium phosphorus sulfur chloride, Li₆PS₅Cl (LPSCl).

Examples of oxide-based solid electrolyte materials include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃ and/or Li₁₊ₓAlₓGe₂₋ₓ(PO₄)₃), and LISICON type (e.g., Li₂₊₂ₓZn₁₋ₓGeO₄). Examples of metal-doped or aliovalent-substituted oxide solid electrolyte materials include Al- or Nb-doped Li₂La₃Zr₂O₁₂, Sb-doped Li₇La₃Zr₂O₁₂, Ga-substituted Li₇La₃Zr₂O₁₂, Cr- and V-substituted LiSn₂P₃O₁₂, and Al-substituted perovskite (e.g., Li_{1+x+y}AlₓTi₂₋ₓSi_{y}P_{3-y}O₁₂). Examples of nitride-based solid electrolyte materials include Li₃N, Li₇PN₄, and LiSi₂N₃. Examples of hydride-based solid electrolytes include LiBH₄, LiBH₄—LiX (X=Cl, Br or I), LiNH₂, Li₂NH, LiBH₄—LiNH₂, and/or Li₃AlH₆. Examples of halide-based solid electrolytes include Li₃YCl₆, Li₃InCl₆, Li₃YBr₆, LiI, Li₂CdCl₄, Li₂MgCl₄, Li₂CdI₄, Li₂ZnI₄, and/or Li₃OCl. Examples of borate-based solid electrolyte materials include Li₂B₄O₇ and Li₂O—B₂O₃—P₂O₅.

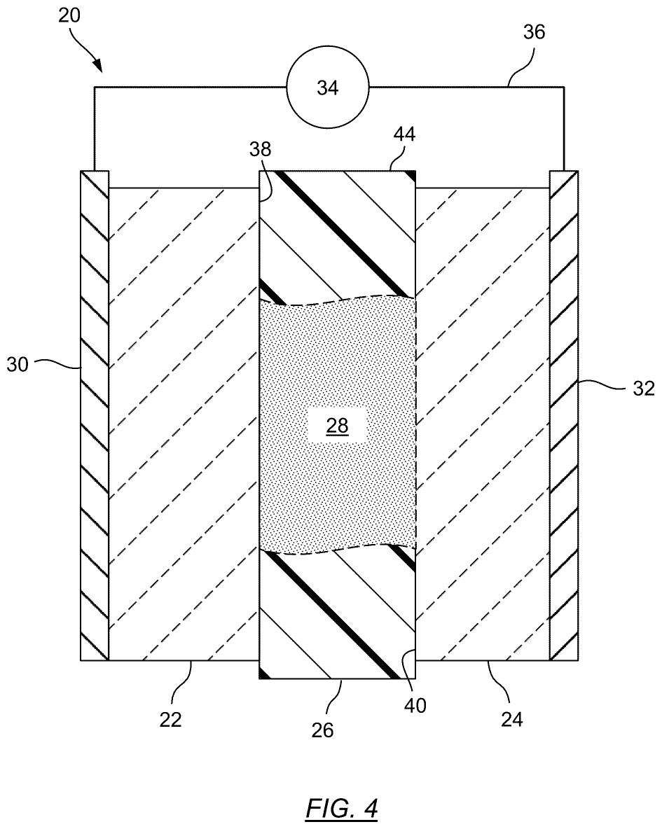

As shown in FIG. 4, in embodiments, the porous separator 26 may be at least partially defined by a polymer-based membrane 44, which may be sandwiched between the major surface 38 of the negative electrode 22 and the major surface 40 of the positive electrode 24. The polymer-based membrane 44 has an open microporous structure comprising a plurality of open pores. In embodiments where the porous separator 26 is at least partially defined by the polymer-based membrane 44, the electrolyte 28 may infiltrate the open pores defined within the polymer-based membrane 44. For example, the electrolyte 28 may infiltrate greater than or equal to 5% and less than or equal to 100% of the open pores defined within the polymer-based membrane 44. In aspects, the electrolyte 28 may infiltrate about 90% of the open pores defined within the polymer-based membrane 44. The polymer-based membrane 44 may have a thickness of greater than or equal to about 5 micrometers (μm), optionally greater than or equal to about 10 μm, or optionally greater than or equal to about 20 μm and less than or equal to about 200 μm, optionally less than or equal to about 100 μm, or optionally less than or equal to about 50 μm.

The polymer-based membrane 44 may comprise a woven or nonwoven polymer. For example, the polymer-based membrane 44 may comprise a polyolefin (e.g., polyethylene, PE, polypropylene, PP, and/or polyacetylene), polyimide (PI), polyamide (PA) (e.g., poly(m-phenylene isophthalamide, PMIA), poly(tetrafluoroethylene) (PTFE), polyvinylidene fluoride (PVDF), poly(vinylidene fluoride-co-hexafluoropropylene), polystyrene (e.g., poly(lithium 4-styrenesulfonate)), polyetherimide (PEI) (e.g., bisphenol-aceton diphthalic anhydride, BPADA, and/or para-phenylenediamine, pPD), cellulose, or a combination thereof. In aspects, the polymer-based membrane 44 may include a ceramic coating. Examples of ceramic materials that may coat surfaces of the polymer-based membrane 44 include SiO₂, Al₂O₃, and combinations thereof.

In aspects, the porous separator 26 may comprise the solid electrolyte particles 42 and the polymer-based membrane 44 (not shown).

The negative electrode 22 is formulated to store and release lithium ions to facilitate charge and discharge, respectively, of the battery 20. The negative electrode 22 may be in the form of a continuous porous layer disposed on the major surface of the negative electrode current collector 30. The negative electrode 22 comprises an electrochemically active (electroactive) material, a polymer binder, and optionally an electrically conductive material. The electroactive material of the negative electrode 22 (electroactive negative electrode material) may be a particulate material and particles of the electroactive material of the negative electrode 22 may be intermingled with the polymer binder and the optional electrically conductive material in the negative electrode 22. In such case, the particles of the electroactive material of the negative electrode 22 may define a plurality of open pores extending through the negative electrode 22.

The electroactive material of the negative electrode 22 is formulated to store and release lithium ions by undergoing a reversible redox reaction with lithium during charge and discharge of the battery 20. Examples of electroactive negative electrode materials include lithium, lithium-based materials (e.g., alloys of lithium and silicon, aluminum, indium, and/or tin), carbon-based materials (e.g., graphite, activated carbon, carbon black, hard carbon, soft carbon, and/or graphene), silicon, silicon-based materials (e.g., alloys of silicon and lithium, tin, iron, aluminum, and/or cobalt), silicon oxide, silicon oxide-based materials (e.g., lithium silicon oxide), tin oxide, aluminum, indium, zinc, germanium, titanium oxide, lithium titanate, and combinations thereof. In embodiments, the electroactive material of the negative electrode 22 may comprise a mixture of silicon and one or more carbon-based materials. The electroactive material of the negative electrode 22 may constitute, by weight, greater than or equal to 30%, optionally greater than or equal to 50%, or optionally greater than or equal to 70%, and less than or equal to 98%, optionally less than or equal to 90%, or optionally less than or equal to 80% of the negative electrode 22.

The polymer binder of the negative electrode 22 is electrochemically inactive and may provide the negative electrode 22 with structural integrity. Examples of polymer binders include polyvinylidene fluoride (PVDF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder of the negative electrode 22 may constitute, by weight, greater than or equal to 5%, or optionally greater than or equal to 10%, and less than or equal to 20% of the negative electrode 22.

The optional electrically conductive material of the negative electrode 22 is electrochemically inactive and may help promote the percolation of electrons through the negative electrode 22. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When present the electrically conductive material of the negative electrode 22 may constitute, by weight, greater than or equal to 5%, or optionally greater than or equal to 10%, and less than or equal to 30% of the negative electrode 22.

The positive electrode 24 is formulated to store and release lithium ions during discharge and charge, respectively, of the battery 20. The positive electrode 24 may be in the form of a continuous porous layer disposed on the major surface of the positive electrode current collector 32. The positive electrode 24 comprises an electroactive material (electroactive positive electrode material), a polymer binder, and optionally an electrically conductive material. The electroactive material of the positive electrode 24 may be a particulate material and particles of the electroactive material of the positive electrode 24 may be intermingled with the polymer binder and the optional electrically conductive material. The particles of the electroactive material of the positive electrode 24 may define a plurality of open pores extending through the positive electrode 24. The same polymer binders and/or electrically conductive materials disclosed above with respect to the negative electrode 22 may be used in the positive electrode 24 in substantially the same amounts.

The electroactive material of the positive electrode 24 is formulated to store and release lithium ions by undergoing a reversible redox reaction with lithium at a higher electrochemical potential than the electroactive material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide. For example, the electroactive material of the positive electrode 24 may comprise a layered lithium transition metal oxide represented by the formula LiMeO₂ and/or Li₂MeO₃, a layered lithium-rich transition metal oxide represented by the formula Li₁₊ₓMe₁₋ₓO₂ (where 0<x≤0.33), an olivine-type lithium transition metal oxide represented by the formula LiMePO₄, a monoclinic-type lithium transition metal oxide represented by the formula Li₃Me₂(PO₄)₃, a spinel-type lithium transition metal oxide represented by the formula LiMe₂O₄, a tavorite represented by one or both of the following formulas LiMeSO₄F or LiMePO₄F, or a combination thereof, where Me is a transition metal (e.g., Co, Ni, Mn, Fe, Al, V, or a combination thereof). In aspects where the electroactive material of the positive electrode 24 comprises a conversion material, the electroactive material of the positive electrode 24 may comprise sulfur, selenium, tellurium, iodine, a halide (e.g., a fluoride or chloride), sulfide (e.g., Li₂S), selenide, telluride, iodide, phosphide, nitride, oxide, oxysulfide, oxyfluoride, sulfur-fluoride, sulfur-oxyfluoride, or a lithium and/or metal compound thereof (e.g., a compound of iron, manganese, nickel, copper, and/or cobalt).

In embodiments where the porous separator 26 comprises the solid electrolyte particles 42, the negative electrode 22 and/or the positive electrode 24 may further comprise solid electrolyte particles (not shown). In such case, the solid electrolyte particles 42 may constitute, by weight, greater than 0%, optionally greater than or equal to 10%, or optionally greater than or equal to 20%, and less than or equal to 50% of the negative electrode 22 and/or the positive electrode 24.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure. Any method steps, processes, and operations described herein are not to be construed as necessarily requiring their performance in the order discussed or illustrated, unless specifically identified as an order of performance. It is also to be understood that additional or alternative steps may be employed, unless otherwise indicated.

As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes combinations of one or more of the associated listed items.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

What is claimed is:

1. An electrolyte for a battery that cycles lithium ions, the electrolyte comprising:
a glyme-based ionic liquid comprising substantially equimolar amounts of a cation component and an anion component, the cation component comprising a complex of lithium (Li⁺) and a glyme, and the anion component comprising an arsenate ion, a phosphate ion, a sulfonylimide ion, a borate ion, a chlorate ion, or a combination thereof; and
a cyclic ammonium-based ionic liquid comprising a cation component and an anion component, the cation component comprising a piperidinium ion, a pyrrolidinium ion, or a combination thereof, and the anion component comprising an arsenate ion, a phosphate ion, a sulfonylimide ion, a borate ion, a chlorate ion, or a combination thereof,
wherein the electrolyte has a lithium concentration of greater than or equal to 0.2 moles per liter and less than or equal to 1.6 moles per liter.

2. The electrolyte of claim 1, wherein the electrolyte has a viscosity of greater than or equal to 10 millipascal-seconds and less than or equal to 100 millipascal-seconds and an ionic conductivity of greater than or equal to 4 milliSiemens per centimeter and less than or equal to 10 milliSiemens per centimeter at 25 degrees Celsius.

3. The electrolyte of claim 2, wherein the glyme-based ionic liquid has a viscosity of greater than 100 millipascal-seconds and the cyclic ammonium-based ionic liquid has a viscosity of less than 100 millipascal-seconds at 25 degrees Celsius.

4. The electrolyte of claim 2, wherein the glyme-based ionic liquid has an ionic conductivity of less than or equal to 2 milliSiemens per centimeter and the cyclic ammonium-based ionic liquid has an ionic conductivity of greater than or equal to 4 milliSiemens per centimeter at 25 degrees Celsius.

5. The electrolyte of claim 1, wherein the cation component of the glyme-based ionic liquid comprises a complex of lithium (Li⁺) and monoglyme, ethyl glyme, diglyme, ethyl diglyme, triglyme, butyl diglyme, tetraglyme, or a combination thereof, and wherein the anion component of the glyme-based ionic liquid comprises hexafluoroarsenate (AsF₆⁻), hexafluorophosphate (PF₆⁻), bis(fluorosulfonyl)imide (FSI), bis(trifluoromethane)sulfonylimide (TFSI), tetrafluoroborate (LiBF₄⁻), perchlorate (ClO₄⁻), or a combination thereof.

6. The electrolyte of claim 1, wherein the glyme-based ionic liquid is formed from a mixture of a glyme and a lithium salt, and wherein a molar ratio of the glyme to the lithium salt in the mixture is greater than or equal to 0.7:1 and less than or equal to 1.2:1.

7. The electrolyte of claim 1, wherein the cation component of the cyclic ammonium-based ionic liquid comprises 1-methyl-1-ethylpyrrolidinium ([Py₁₂]⁺), 1-propyl-1-methylpyrrolidinium ([Py₁₃]⁺), 1-butyl-1-methylpyrrolidinium ([Py₁₄]⁺), 1-propyl-1-methylpiperidinium ([PP₁₃]⁺), 1-butyl-1-methylpiperidinium ([PP₁₄]⁺), or a combination thereof, and wherein the anion component of the cyclic ammonium-based ionic liquid comprises hexafluoroarsenate (AsF₆⁻), hexafluorophosphate (PF₆⁻), bis(fluorosulfonyl)imide (FSI), bis(trifluoromethane)sulfonylimide (TFSI), tetrafluoroborate (LiBF₄⁻), perchlorate (ClO₄⁻), or a combination thereof.

8. The electrolyte of claim 1, wherein the cation component of the glyme-based ionic liquid comprises a complex of lithium (Li⁺) and tetraglyme, the anion component of the glyme-based ionic liquid comprises bis(fluorosulfonyl)imide (FSI), the cation component of the cyclic ammonium-based ionic liquid comprises 1-propyl-1-methylpyrrolidinium ([Py₁₃]⁺), and the anion component of the cyclic ammonium-based ionic liquid comprises bis(fluorosulfonyl)imide (FSI).

9. The electrolyte of claim 1, wherein a volumetric ratio of the glyme-based ionic liquid to the cyclic ammonium-based ionic liquid in the electrolyte is greater than or equal to 1:10 and less than or equal to 2:1.

10. The electrolyte of claim 1, wherein the electrolyte is substantially free of nonaqueous aprotic organic solvents.

11. A battery that cycles lithium ions, the battery comprising:
a negative electrode comprising an electroactive negative electrode material comprising silicon;
a positive electrode spaced apart from the negative electrode and comprising an electroactive positive electrode material;
a porous separator disposed between the negative electrode and the positive electrode and having a plurality of open pores extending therethrough; and
an electrolyte infiltrating the open pores of the porous separator and configured to provide a medium for the conduction of lithium ions through the porous separator and between the negative electrode and the positive electrode, the electrolyte comprising:
a glyme-based ionic liquid comprising substantially equimolar amounts of a cation component and an anion component, the cation component comprising a complex of lithium (Li⁺) and a glyme, and the anion component comprising an arsenate ion, a phosphate ion, a sulfonylimide ion, a borate ion, a chlorate ion, or a combination thereof, and
a cyclic ammonium-based ionic liquid comprising a cation component and an anion component, the cation component comprising a piperidinium ion, a pyrrolidinium ion, or a combination thereof, and the anion component comprising an arsenate ion, a phosphate ion, a sulfonylimide ion, a borate ion, a chlorate ion, or a combination thereof,
wherein the electrolyte has a lithium concentration of greater than or equal to 0.2 moles per liter and less than or equal to 1.6 moles per liter.

12. The battery of claim 11, wherein the electrolyte has a viscosity of greater than or equal to 10 millipascal-seconds and less than or equal to 100 millipascal-seconds and an ionic conductivity of greater than or equal to 4 milliSiemens per centimeter and less than or equal to 10 milliSiemens per centimeter at 25 degrees Celsius.

13. The battery of claim 11, wherein a molar ratio of the cation component to the anion component of the glyme-based ionic liquid is greater than or equal to 0.7:1 and less than or equal to 1.2:1.

14. The battery of claim 11, wherein the cation component of the glyme-based ionic liquid comprises a complex of lithium (Li⁺) and tetraglyme, the anion component of the glyme-based ionic liquid comprises bis(fluorosulfonyl)imide (FSI), the cation component of the cyclic ammonium-based ionic liquid comprises 1-propyl-1-methylpyrrolidinium ([Py₁₃]⁺), and the anion component of the cyclic ammonium-based ionic liquid comprises bis(fluorosulfonyl)imide (FSI).

15. The battery of claim 14, wherein a volumetric ratio of the glyme-based ionic liquid to the cyclic ammonium-based ionic liquid in the electrolyte is greater than or equal to 1:10 and less than or equal to 2:1.

16. The battery of claim 11, wherein the porous separator comprises solid electrolyte particles.

17. The battery of claim 16, wherein the solid electrolyte particles comprise a sulfide-based solid electrolyte material comprising lithium sulfide (Li₂S) and at least one element selected from the group consisting of phosphorus (P), tin (Sn), silicon (Si), germanium (Ge), boron (B), gallium (Ga), and aluminum (Al).

18. The battery of claim 17, wherein the negative electrode further comprises a polymer binder, an electrically conductive material, and sulfide-based solid electrolyte particles.

19. The battery of claim 11, wherein the porous separator comprises a polymer-based membrane.

20. The battery of claim 11, wherein the electroactive positive electrode material comprises sulfur.
